(19) United States
(12) Patent Application Publication
(10) Pub. No.: US 2009/0102771 A1
(43) Pub. Date: Apr. 23, 2009

(54) Image processing apparatus, image display and image processing method

(75) Inventors: Hiroshi Sugisawa, Kanagawa (JP); Toshio Sarugaku, Chiba (JP); Tomohiko Itoyama, Chiba (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 12/285,918

(22) Filed: Oct. 16, 2008

(30) Foreign Application Priority Data
Oct. 19, 2007 (JP) 2007-272503

(51) Int. Cl. G09G 3/36

(52) U.S. Cl. 345/89

(57) ABSTRACT

An image processing apparatus includes: a detection means for detecting a motion index of an input picture; a generation means for generating a mask signal for a fluctuation pixel region due to a line flicker component; a mask processing means for performing a mask process on the motion index through the use of the mask signal; a frame division means; and a gray-scale conversion means for selectively performing, on the basis of the motion index subjected to the mask process, adaptive gray-scale conversion on a luminance signal in a pixel region where a motion index is larger than a predetermined threshold value so that, while maintaining total time integral value of the luminance signal in the unit frame period as it is, a high luminance period and a low luminance period are allocated to sub-frame periods in the unit frame period, respectively.

### CROSS REFERENCES TO RELATED APPLICATIONS

The present invention contains subject matter related to Japanese Patent Application JP 2007-272503 filed in the Japanese Patent Office on Oct. 19, 2007, the entire contents of which being incorporated herein by reference.

### BACKGROUND OF THE INVENTION

1. Field of the Invention

The present invention relates to an image processing apparatus and an image processing method which are suitably applied to a hold-type image display, and an image display including such an image processing apparatus.

2. Description of the Related Art

As means for improving motion picture response by performing pseudo-impulse display by an image display (for example, a liquid crystal display (LCD)) which performs hold-type display, black insertion techniques such as black frame insertion or backlight blinking are widely used in commercially available LCDs. However, in these techniques, a black insertion ratio is increased to achieve an effect of improving motion picture response, so there is an issue that display luminance becomes lower with increasing a black insertion ratio.

Therefore, for example, in International Publication No. 2006/009106 pamphlet, a pseudo impulse display method (hereinafter referred to as improved pseudo impulse drive) capable of improving motion picture response without sacrificing display luminance is proposed. In this method, in the case where an input gray scale (a luminance gradation level of a video signal) is temporally changed, adaptive gray-scale conversion is performed so that a unit frame period of a video signal is divided into two sub-frame periods (sub-frame periods 1 and 2) (for example, a unit frame period with a normal display frame rate of 60 Hz is divided into two sub-frame periods with a frame rate of 120 Hz which is twice as high as the normal display frame rate), and an (input/output) gray-scale conversion characteristic is divided into a gray-scale conversion characteristic corresponding to the sub-frame period 1 (a gray-scale conversion characteristic having higher luminance than original luminance) and a gray-scale conversion characteristic corresponding to the sub-frame period 2 (a gray-scale conversion characteristic having lower luminance than the original luminance). Then, when average luminance (a time integration value of luminance) in the unit frame period is maintained before and after gray-scale conversion, pseudo impulse drive is performable without sacrificing display luminance, and low motion picture response caused by hold-type display is overcome.

### SUMMARY OF THE INVENTION

However, in improved pseudo impulse drive, there is an issue that when the transmittance of a liquid crystal is changed in response to the pseudo impulse drive, a change in the transmittance of the liquid crystal appears just like a normal frame rate, and flicker at the normal frame rate is observed.

Therefore, it is considered that the above-described improved pseudo impulse drive is not uniformly applied to the whole screen, but is selectively applied to a portion where it is desired to improve motion picture response (for example, an edge portion of an motion picture). In such a case, it is considered that motion information or edge information for each pixel is detected, and the improved pseudo impulse drive is selectively performed on the basis of the detection result.

However, in such a configuration, when irregular motion occurs in a picture subjected to processing, or when a too large noise component is overlapped with a video signal, a processing region for improved pseudo impulse drive temporally fluctuates (temporally becomes unstable), so a gray-scale expression balance by a combination of light and dark gray scales in improved pseudo impulse drive is lost, and as a result, a noise or flicker may occur in a displayed picture to cause degradation in picture quality. More specifically, for example, in the case where IP (Interlace to Progressive) conversion is performed on an input video signal, a line flicker component along a horizontal direction may be generated at the time of the IP conversion, and fluctuations in a motion information detection region (a processing region for improved pseudo impulse drive) due to such a line flicker component may be one of causes of the generation of the above-described noise component. Therefore, in the case where a line flicker component is contained in an input picture, it is difficult to achieve a balance between a reduction in a sense of flicker and an improvement in motion picture response, and there is room for improvement.

In view of the foregoing, it is desirable to provide an image processing apparatus, an image display and an image processing method which are capable of achieving a balance between a reduction in a sense of flicker and an improvement in motion picture response irrespective of the presence or absence of a line flicker component in an input picture.

According to an embodiment of the invention, there is provided an image processing apparatus including: a detection means for detecting the motion index of an input picture for each pixel; a generation means; a mask processing means; a frame division means for dividing a unit frame period of the input picture into a plurality of sub-frame periods; and a gray-scale conversion means. In this case, the above-described generation means generates, on the basis of the input picture, a mask signal for a fluctuation pixel region where the motion index fluctuates due to a line flicker component contained in the input picture. Moreover, the above-described mask processing means performs a mask process on the motion index for each pixel through the use of the mask signal. Further the above-described gray-scale conversion means selectively performs, on the basis of the motion index subjected to the mask process, adaptive gray-scale conversion on a luminance signal in a pixel region where a motion index larger than a predetermined threshold value is detected from the luminance signal of the input picture so that, while maintaining total time integral value of the luminance signal in the unit frame period as it is, a high luminance period having a luminance level higher than an original luminance signal and a low luminance period having a luminance level lower than the original luminance signal are allocated to sub-frame periods in the unit frame period, respectively.

According to an embodiment of the invention, there is provided an image display including: the above-described detection means, the above-described generation means, the above-described mask processing means, the above-described frame division means, the above-described gray-scale conversion means and a display means for displaying a picture on the basis of a luminance signal subjected to adaptive gray-scale conversion by the gray-scale conversion means.

According to an embodiment of the invention, there is provided an image processing method including: a detection step of detecting a motion index of an input picture for each pixel; a generation step; a mask processing step; a frame division step of dividing a unit frame period of the input picture into a plurality of sub-frame periods; and a gray-scale conversion step. In this case, in the above-described generation step, a mask signal for a fluctuation pixel region where the motion index fluctuates due to a line flicker component contained in the input picture is generated on the basis of the input picture. Moreover, in the above-described mask processing step, a mask process on the motion index for each pixel is performed through the use of the mask signal. Further, in the above-described gray-scale conversion step, adaptive gray-scale conversion is selectively performed on a luminance signal in a pixel region where a motion index larger than a predetermined threshold value is detected from the luminance signal of the input picture on the basis of the motion index subjected to the mask process so that, while maintaining total time integral value of the luminance signal in the unit frame period as it is, a high luminance period having a luminance level higher than an original luminance signal and a low luminance period having a luminance level lower than the original luminance signal are allocated to sub-frame periods in the unit frame period respectively.

In the image processing apparatus, the image display and the image processing method according to the embodiment of the invention, the motion index of the input picture for each pixel is detected, and the unit frame period of the input picture is divided into a plurality of sub-frame periods. Then, adaptive gray-scale conversion is selectively performed on a luminance signal in a pixel region where a motion index larger than a predetermined threshold value is detected from the luminance signal of the input picture so that, while maintaining total time integral value of the luminance signal in the unit frame period as it is, a high luminance period and a low luminance period are allocated to sub-frame periods in the unit frame period, respectively. Thus, adaptive gray-scale conversion is selectively performed on the luminance signal in the pixel region where the motion index is larger than the predetermined threshold value, so motion picture response is improved by pseudo impulse drive, and compared to the case where adaptive gray-scale conversion is performed on luminance signals in the whole pixel region in a related art, a sense of flicker is reduced. Moreover, a mask signal for a fluctuation pixel region where the motion index fluctuates due to the line flicker component contained in the input picture is generated, and the mask process on the motion index through the use of the mask signal is performed for each pixel, and the above-described adaptive gray-scale conversion is performed on the basis of the motion index subjected to such a mask process, so even in the case where the line flicker component is contained in the input picture, the motion index is prevented from fluctuating due to such a line flicker component, and the detected motion index is stabilized along a time axis.

In the image processing apparatus according to the embodiment of the invention, the above-described generation means may include a difference signal generation means and a vertical edge detection means for detecting an edge index in a vertical direction of the current input picture for each pixel, and a mask signal generation means. In this case, the above-described difference signal generation means generates, for each pixel, a first difference signal as a difference signal between the current input picture and an input picture of a sub-frame period which precedes the current input picture by four sub-frame periods, and a second difference signal as a difference signal between the current input picture and an input picture of a sub-frame period which follows the current input picture by four sub-frame periods. Moreover, the above-described mask signal generation means generates the mask signal for each pixel on the basis of the first and the second difference signals generated and the edge index.

In the image processing apparatus, the image display or the image processing method according to the embodiment of the invention, the motion index of the input picture for each pixel is detected, and the unit frame period of the input picture is divided into a plurality of sub-frame periods, and adaptive gray-scale conversion is performed on a luminance signal in a pixel region where a motion index larger than a predetermined threshold value is detected from the luminance signal of the input picture so that, while maintaining total time integral value of the luminance signal in the unit frame period as it is, the high luminance period and the low luminance period are allocated to sub-frame periods in the unit frame period, respectively, so motion picture response is able to be improved by pseudo impulse drive, and compared to the case where adaptive gray-scale conversion is performed on luminance signals in the whole pixel region in the related art, a sense of flicker is able to be reduced. Moreover, a mask signal for the fluctuation pixel region where the motion index fluctuates due to a line flicker component contained in the input picture is generated on the basis of the input picture, and the mask process on the motion index for each pixel is performed through the use of the mask signal, and the above-described adaptive gray-scale conversion is performed on the basis of the motion index subjected to such a mask process, so even in the case where the line flicker component is contained in the input picture, the motion index is prevented from fluctuating due to such a line flicker component, thereby the detected motion index is able to be stabilized along the time axis. Therefore, irrespective of the presence or absence of a line flicker component in the input picture, a balance between a reduction in the sense of flicker and an improvement in motion picture response is able to be achieved.

Other and further objects, features and advantages of the invention will appear more fully from the following description.

### BRIEF DESCRIPTION OF THE DRAWINGS

FIG. 1 is a block diagram showing the whole configuration of an image display including an image processing apparatus according to an embodiment of the invention;

FIG. 2 is a plot showing a luminance γ characteristic at the time of gray-scale conversion by a gray-scale conversion section shown in FIG. 1;

FIG. 3 is a block diagram showing a specific configuration of a motion detection section shown in FIG. 1;

FIG. 4 is an illustration for describing a reference range of a sub-frame in the motion detection section;

FIG. 5 is a plot for describing a detection threshold value in an edge adaptive motion detection section shown in FIG. 3;

FIG. 6 is a schematic view for describing a basic operation of a processing region detection section shown in FIG. 1;

FIG. 7 is a timing waveform chart showing input/output characteristics of a luminance signal before gray-scale conversion;

FIG. 8 is a timing waveform charge showing input/output characteristics of a luminance signal after gray-scale conversion;

FIG. 9 is a block diagram showing the whole configuration of an image display including an image processing apparatus according to a comparative example;

FIG. 10 is a block diagram showing a specific configuration of a motion detection section according to the comparative example shown in FIG. 9;

FIG. 11 is a timing chart for describing an example of motion detection operation in the case where line flicker does not occur in the comparative example;

FIG. 12 is a timing chart for describing an example of motion detection operation in the case where line flicker occurs in the comparative example;

FIG. 13 is a timing chart for describing an example of motion detection operation in the case where line flicker occurs in the embodiment; and

FIG. 14 is a timing chart for describing an example of motion detection operation in the case where line flicker occurs, following FIG. 13.

### DETAILED DESCRIPTION OF THE PREFERRED EMBODIMENTS

A preferred embodiment will be described in detail below referring to the accompanying drawings.

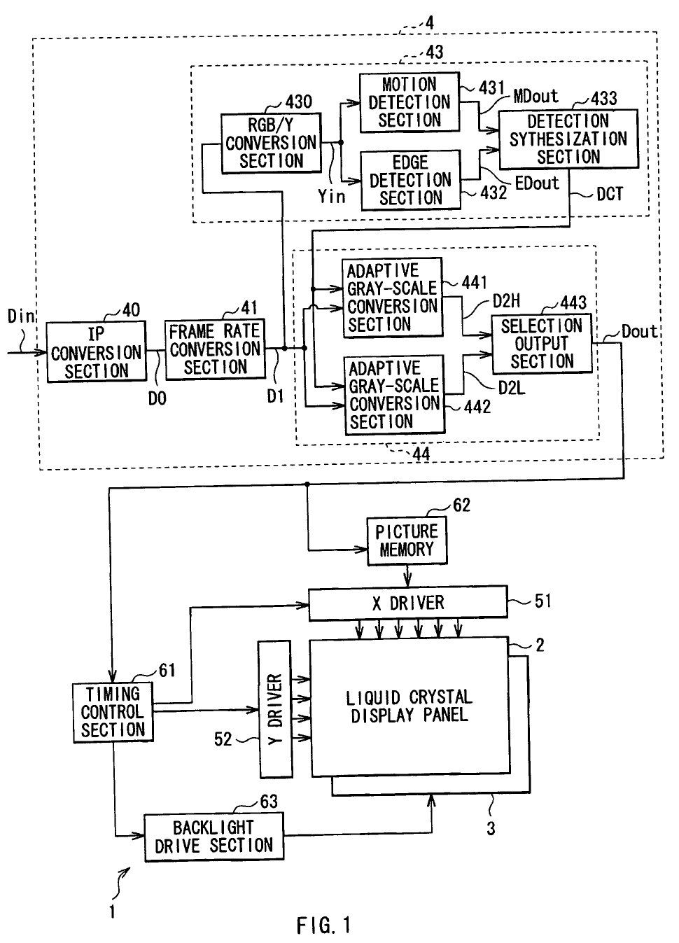

FIG. 1 shows the whole configuration of an image display (a liquid crystal display 1) including an image processing apparatus (an image processing section 4) according to an embodiment of the invention. The liquid crystal display 1 includes a liquid crystal display panel 2, a backlight section 3, an image processing section 4, a picture memory 62, an X driver 51, a Y driver 52, a timing control section 61 and a backlight control section 63. In addition, an image processing method according to an embodiment is embodied by the image processing apparatus according to the embodiment, and will be also described below.

The liquid crystal display panel 2 displays a picture corresponding to, for example, a TV signal Din by a drive signal supplied from the X driver 51 and the Y driver 52 which will be described later, and includes a plurality of pixels (not shown) arranged in a matrix form.

The backlight section 3 is a light source applying light to the liquid crystal display panel 2, and includes, for example, a CCFL (Cold Cathode Fluorescent Lamp), an LED (Light Emitting Diode) or the like.

The image processing section 4 performs predetermined image processing which will be described later on the TV signal Din from outside to generate a video signal Dout, and includes an IP conversion section 40, a frame rate conversion section 41, a conversion region detection section 43 and a gray-scale conversion section 44.

The IP conversion section 40 performs IP conversion in which the TV signal Din as an interlaced signal (30 Hz) is converted into a noninterlaced signal (a progressive signal) (60 Hz) to generate a video signal D0 as a progressive signal.

The frame rate conversion section 41 converts the frame rate (in the case of a progressive signal, 60 Hz) of the video signal D0 into a higher frame rate (for example 120 Hz). More specifically, the unit frame period (in the case of a progressive signal, ( 1/60) seconds) of the video signal D0 is divided into a plurality of (for example, two) sub-frame periods (for example, ( 1/120) seconds) to generate a video signal D1 consisting, for example, two sub-frame periods. As a method of generating the video signal D1 by such frame rate conversion, for example, a method of producing an interpolation frame by motion detection or a method of producing an interpolation frame by simply duplicating the original video signal D0 is considered.

The conversion region detection section 43 detects motion information (a motion index) MDout and edge information (an edge index) EDout for each pixel in each sub-frame period from the video signal D1 supplied from the frame rate conversion section 41, and includes an RGB/Y conversion section 430, a motion detection section 431, an edge detection section 432 and a detection synthesization section 433.

The RGB/Y conversion section 430 converts the video signal D1 as an RGB signal including a luminance signal and a color-difference signal into a luminance signal Yin to output the luminance signal Yin. The motion detection section 431 detects motion information MDout for each pixel in each sub-frame period from the luminance signal Yin, and the edge detection section 432 detects edge information EDout for each pixel in each sub-frame period from the luminance signal Yin. The detection synthesization section 433 combines the motion information MDout supplied from the motion detection section 431 and the edge information EDout supplied from the edge detection section 432, and generates and outputs a detection result synthesization signal DCT by performing various adjustment processes (a detection region expanding process, a detection region rounding process, an isolated point detection process or the like). In addition, the configuration of the motion detection section 431 and detection operation by the conversion region detection section 43 will be described in detail later.

As a motion detection method by the motion detection section 431, for example, a method of detecting a motion vector by a block matching method, a method of detecting a motion vector between sub-frames through the use of a difference signal between sub-frames, or the like is cited. Moreover, as an edge detection method by the edge detection section 432, a method of performing edge detection by detecting a pixel region in which a luminance level (gray scale) difference between a pixel and its neighboring pixel is larger than a predetermined threshold value in each sub-frame period, or the like is cited.

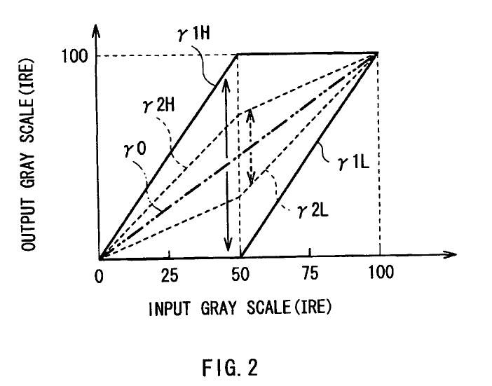

The gray-scale conversion section 44 selectively performs adaptive gray-scale conversion which will be described later on a video signal in a pixel region in which the motion information MDout and the edge information EDout larger than a predetermined threshold value are detected from the inputted video signal D1 in response to the detection result synthesization signal DCT supplied from the conversion region detection section 43, and includes two adaptive gray-scale conversion sections 441 and 442 and the selection output section 443. More specifically, for example, as shown in FIG. 2, the (input/output) gray-scale conversion characteristic (a luminance γ characteristic) γ0 of the video signal D1 is converted into a luminance γ characteristic γ1H higher luminance than original luminance and a luminance γ characteristic γ1L lower luminance than the original luminance by the adaptive gray-scale conversion sections 441 and 442, respectively, and the selection output section 443 alternately selects and outputs video signals (luminance signals) D21H and D21L corresponding to the two luminance γ characteristics γ1H and γ1L, respectively, in each sub-frame period, thereby the video signal Dout is generated and outputted.

In addition, adaptive gray-scale conversion may be performed on the luminance γ characteristic γ0 of the video signal D1 through the use of, for example, luminance γ characteristics γ2H and γ2L in FIG. 2 instead of the luminance γ characteristics γ1H and γ1L. However, the luminance γ characteristics γ1H and γ1L are preferably used, because an effect of improving motion picture response is higher in the case where the adaptive gray-scale conversion is performed through the use of the luminance γ characteristics γ1H and γ1L than in the case where the adaptive gray-scale conversion is performed through the use of the luminance γ characteristics γ2H and γ2L. Moreover, in FIG. 2, the luminance γ characteristic γ0 is a linear straight line; however, the luminance γ characteristic γ0 may be a non-linear curve such as so-called γ2.2.

The picture memory 62 is a frame memory (a sub-frame memory) storing the video signal Dout for each pixel on which adaptive gray-scale conversion is performed by the image processing section 4 in each sub-frame period. The timing control section (timing generator) 61 controls the drive timings of the X driver, 51, the Y driver 52 and the backlight drive section 63 on the basis of the video signal Dout. The X driver (data driver) 51 supplies a drive voltage corresponding to the video signal Dout to each pixel of the liquid crystal display panel 2. The Y driver (gate driver) 52 line-sequentially drives each pixel in the liquid crystal display panel 2 along a scanning line (not shown) according to timing control by the timing control section 61. The backlight drive section 63 controls the lighting operation of the backlight section 3 according to timing control by the timing control section 61.

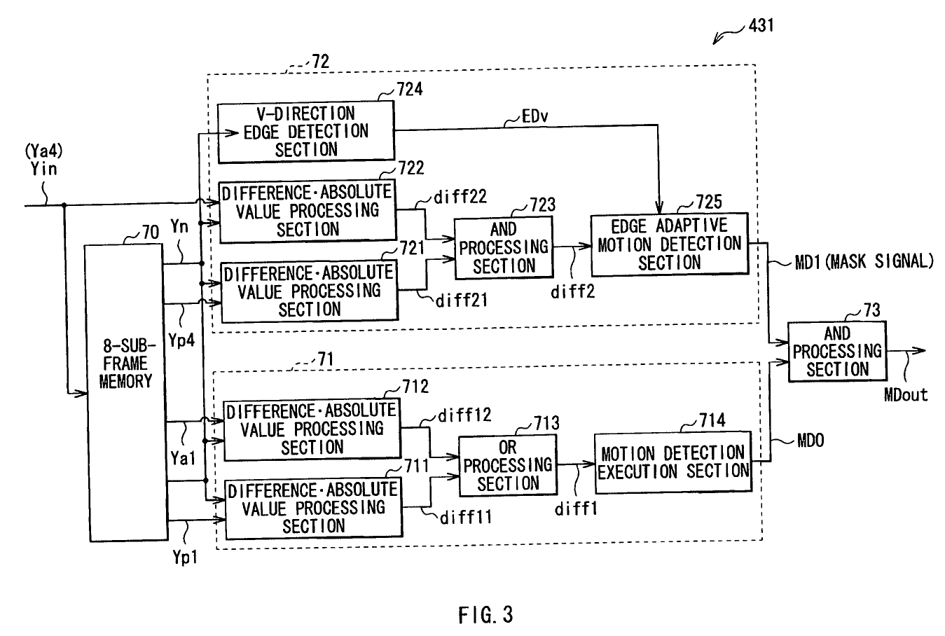

Next, referring to FIG. 3, the configuration of the motion detection section 431 will be described in detail below. FIG. 3 shows a block diagram of the motion detection section 431.

The motion detection section 431 includes an 8-sub-frame memory 70, a motion detection processing section 71 which detects motion information MD0 of the luminance signal Yin on the basis of difference signals for each pixel between the luminance signal Yn of the current sub-frame period and luminance signals Yp1 and Ya1 of preceding and succeeding sub-frame periods, a mask signal generation section 72 which, in the case where a line flicker component generated at the time of IP conversion by the IP conversion section 40 is contained in the luminance signal Yin, generates a mask signal (a mask signal MD1) for a fluctuation pixel region where motion information fluctuates due to the line flicker component on the basis of the luminance signal Yin, and an AND processing section 73.

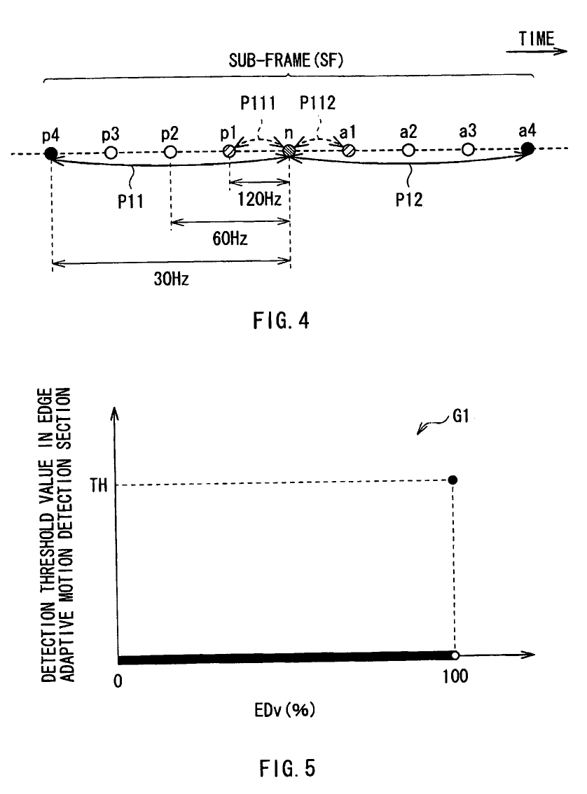

As shown in FIG. 4, the 8-sub-frame memory 70 stores luminance signals Yin of 8 sub-frame periods (the luminance signal Yn of the current sub-frame period, a luminance signal Yp4 of a sub-frame period which precedes the current sub-frame period by four sub-frame periods, a luminance signal Yp3 of a sub-frame period which precedes the current sub-frame period by three sub-frame periods, a luminance signal Yp2 of a sub-frame period which precedes the current sub-frame period by two sub-frame periods, a luminance signal Yp1 of a preceding sub-frame period, a luminance signal Ya1 of a succeeding sub-frame period, a luminance signal Ya2 of a sub-frame period which follows the current sub-frame period by two sub-frame periods, a luminance signal Ya3 of a sub-frame period which follows the current sub-frame period by three sub-frame periods) for each pixel.

The motion detection processing section 71 includes a difference•absolute value processing section 711 which computes a difference between the luminance signal Yn of the current sub-frame period and the luminance signal Yp1 of the preceding sub-frame period, and performs predetermined absolute value processing to generate a difference signal diff11, a difference•absolute value processing section 712 which computes a difference between the luminance signal Yn of the current sub-frame period and the luminance signal Ya1 of the succeeding sub-frame period, and performs predetermined absolute value processing to generate a difference signal diff12, an OR processing section 713 which performs OR processing (logical sum operation processing) of two generated difference signals diff11 and diff12 to generate an OR processing signal (a logical sum signal) diff1, and a motion detection execution section 714 which executes a motion detection process on the generated OR processing signal diff1 for each pixel to generate the motion information MD0. In addition, motion detection process operation by the motion detection processing section 71 will be described in detail later.

The mask signal generation section 72 includes a difference•absolute value processing section 721 which computes a difference between the luminance signal Yn of the current sub-frame period and the luminance signal Yp4 of the sub-frame period which precedes the current sub-frame period by four sub-frame periods, and performs predetermined absolute value processing to generate a difference signal diff21 (a first difference signal), a difference•absolute value processing section 722 which computes a difference between the luminance signal Yn of the current sub-frame period and the luminance signal Ya4 (Yin) of the sub-frame period which follows the current sub-frame period by four sub-frame periods, and performs predetermined absolute value processing to generate a difference signal diff22 (a second difference signal), and an AND processing section 723 which performs AND processing (logical product operation processing) of two generated difference signals diff21 and diff22 to generate an AND processing signal (a logical product signal) diff2. The mask signal generation section 72 further includes a V-direction edge detection section 724 which detects vertical direction (V direction) edge information for each pixel from the luminance signal Yn of the current sub-frame period to output vertical edge information EDv, and an edge adaptive motion detection section 725 which generates a mask signal MD1 for each pixel on the basis of the AND processing signal diff2 generated by the AND processing section 723 and the vertical edge information EDv detected by the V-direction edge detection section 724. The edge adaptive motion detection section 725 generates the above-described mask signal MD1 specifically by performing adaptive motion detection on the AND processing signal diff2, more specifically by adaptively changing a detection threshold value TH for adaptive motion detection, for example, as shown in FIG. 5 on the basis of the vertical edge information EDv. In addition, mask signal generation operation by the mask signal generation section 72 will be described in detail later.

In the case where the above-described fluctuation pixel region is included in the motion information MD0 detected by the motion detection processing section 71, the AND processing section 73 performs a mask process on motion information MD0 for each pixel through the use of the mask signal MD1 generated by the mask signal generation section 72 to generate the motion information MDout as a final output result. In addition, a mask process by the AND processing section 73 will be described in detail later.

Herein, the liquid crystal display panel 2 and the backlight section 3 correspond to specific examples of “a display means” in the invention. Moreover, the frame rate conversion section 41 corresponds to a specific example of “a frame division means” in the invention, and the gray-scale conversion section 44 corresponds to a specific example of “a gray-scale conversion means” in the invention. Further, the motion detection processing section 71 corresponds to “a detection means” in the invention, and the mask signal generation section 72 corresponds to a specific example of “a generation means” in the invention, and the AND processing section 73 corresponds to a specific example of “a mask processing means” in the invention. Moreover, the difference•absolute value processing sections 721 and 722 correspond to specific examples of “a difference signal generation means” in the invention, and the V-direction edge detection section 724 corresponds to a specific example of “a vertical edge detection means” in the invention, and the AND processing section 723 and the edge-adaptive motion detection section 725 correspond to specific examples of “a mask signal generation means” in the invention.

Next, operations of the image processing section 4 having such a configuration and the whole liquid crystal display 1 according to the embodiment will be described in detail below.

At first, referring to FIGS. 1, 2 and 6 to 8, basic operations of the image processing section 4 and the whole liquid crystal display 1 will be described below.

In the whole liquid crystal display 1 according to the embodiment, as shown in FIG. 1, image processing is performed on the TV signal Din supplied from outside by the image processing section 4, thereby the video signal Dout is generated.

More specifically, at first, the IP conversion section 40 performs IP conversion on the TV signal Din as an interlaced signal (30 Hz), thereby the video signal D0 as a progressive signal (60 Hz) is generated. Next, the frame rate conversion section 41 converts the frame rate (60 Hz) of the video signal D0 into a higher frame rate (for example, 120 Hz). More specifically, the unit frame period (( 1/60) seconds) of the video signal D0 is divided into two sub-frame periods (( 1/120) seconds), thereby the video signal D1 including two sub-frame periods SF1 and SF2 is generated.

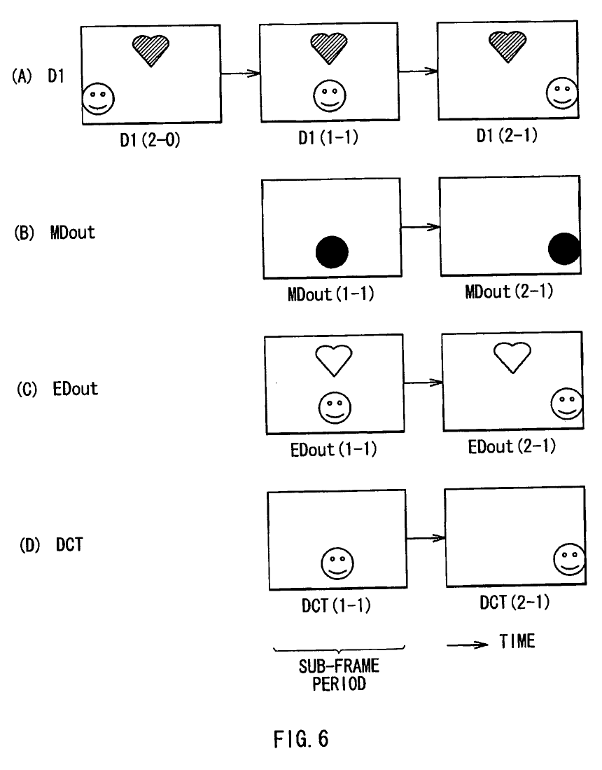

Next, in the conversion region detection section 43, for example, as shown in FIG. 6, the motion information MDout and the edge information EDout are detected, and a conversion region is detected on the basis of the motion information MDout and the edge information EDout. More specifically, when the video signal D1 (video signals (D1(2-0), D1(1-1) and D1(2-1)) as a base of a displayed picture shown in FIG. 6(A) is inputted, for example, motion information MDOut (motion information MDout(1-1), MDout(2-1)) as shown in, for example, FIG. 6(B) is detected by the motion detection section 431, and the edge information EDout (edge information EDout(1-1) and EDout(2-1)) as shown in, for example, FIG. 6(C) is detected by the edge detection section 432. Then, on the basis of the motion information MDout and the edge information EDout detected in such a manner, the detection result synthesization signal DCT (detection result synthesization signals DCT(1-1) and DCT(2-1)) as shown in, for example, FIG. 6(D) is generated by the detection synthesization section 433. Thereby, a region (a conversion region) subjected to gray-scale conversion in the gray-scale conversion section 44, that is, an edge region in a motion picture which causes a decline in motion picture response is specified.

Next, in the gray-scale conversion section 44, on the basis of the video signal D1 supplied from the frame rate conversion section 41 and the detection result synthesization signal DCT supplied from the conversion region detection section 43, while adaptive gray-scale conversion (gray-scale conversion in response to improved pseudo impulse drive) using, for example, the luminance γ characteristics γ1H and γ1L shown in FIG. 2 is performed on a video signal in a pixel region (a detection region; more specifically, for example, an edge region in a motion picture) in which motion information MDout and edge information EDout larger than a predetermined threshold value are detected from the video signal D1, adaptive gray-scale conversion is not performed on a video signal in a pixel region (a pixel region other than the detection region) in which motion information MDout and edge information EDout smaller than the predetermined threshold value are detected from the video signal D1, and the video signal D1 using the luminance γ characteristic γ0 is outputted as it is. In other words, adaptive gray-scale conversion is selectively performed on a video signal in a pixel region in which the motion information MDout and the edge information EDout of the video signal D1 are larger than the predetermined threshold value to perform pseudo impulse drive.

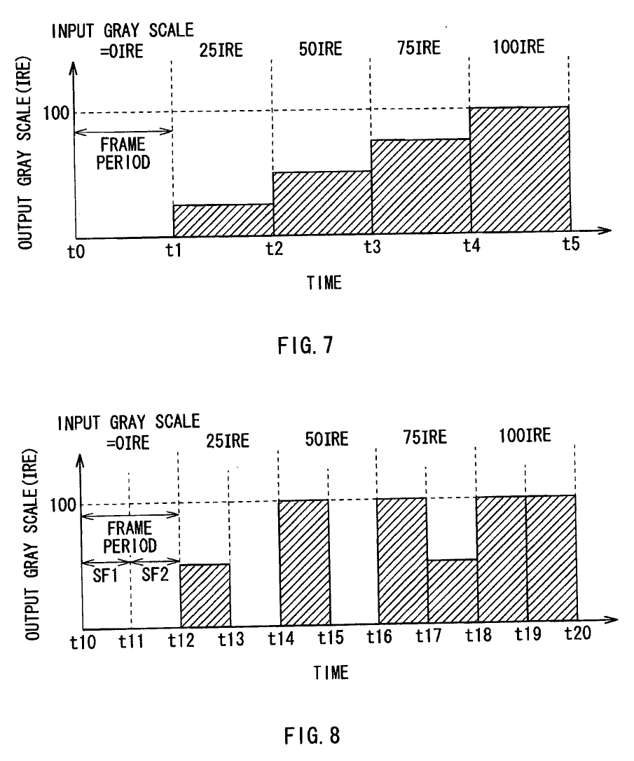

Therefore, in the pixel region (the detection region) in which the adaptive gray-scale conversion is performed, in the case where the luminance gray-scale level (the input gray scale) of the video signal D1 is temporally changed (timings t1 to t5) as shown in, for example FIG. 7, selective adaptive gray-scale conversion is performed on the luminance gray-scale level (the input gray scale) of the video signal Dout after adaptive gray-scale conversion so that, for example, as shown in FIG. 8 (timings t10 to t20), while a time integral value of luminance in the unit frame period is maintained, a high luminance period (the sub-frame period SF1) having a luminance level higher luminance than the luminance level of the original video signal D1 and a low luminance period (the sub-frame period SF2) having a luminance level lower luminance than the luminance level of the original video signal D1 are allocated to sub-frame periods in the unit frame period. In other words, pseudo impulse drive is performed without sacrificing display luminance, and low motion picture response due to hold-type display is overcome.

Next, illumination light from the backlight section 3 is modulated by a drive voltage (a pixel application voltage) outputted from the X driver 51 and the Y driver 52 to each pixel on the basis of the video signal (luminance signal) Dout on which gray-scale conversion is performed in such a manner to be outputted from the liquid crystal display panel 2 as display light. Thus, image display is performed by the display light corresponding to the TV signal Din.

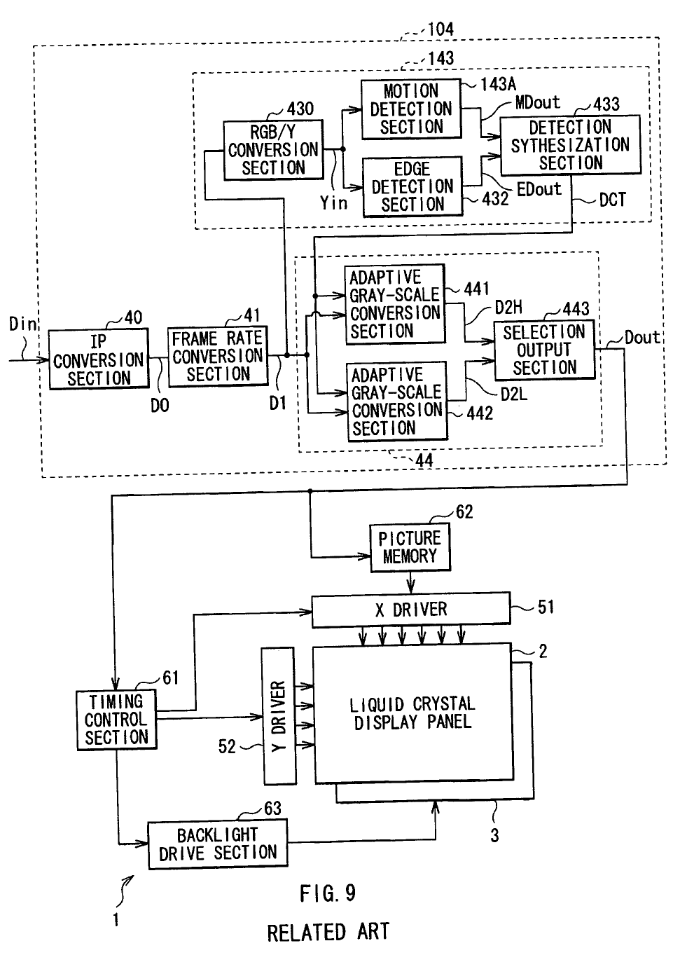

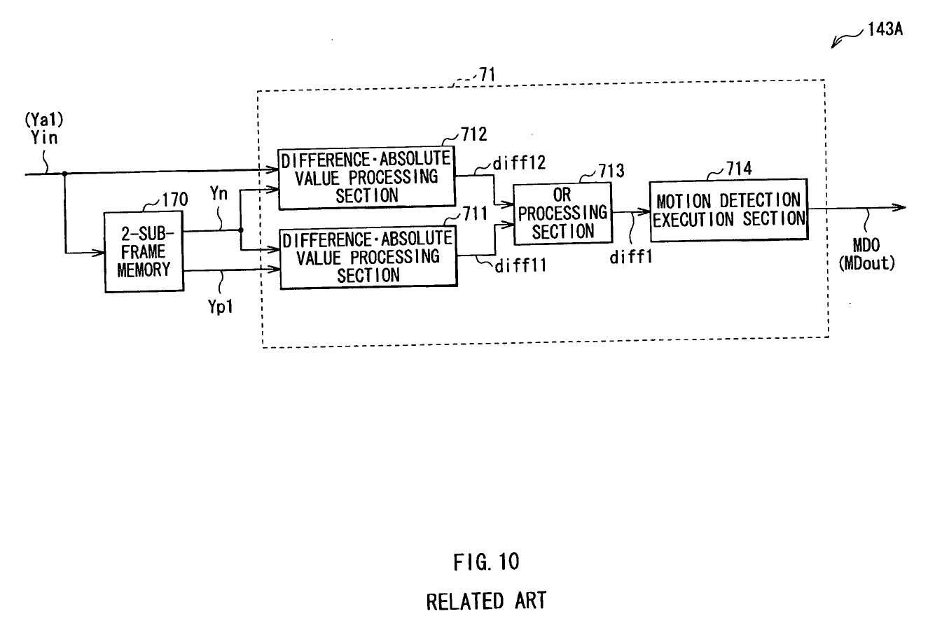

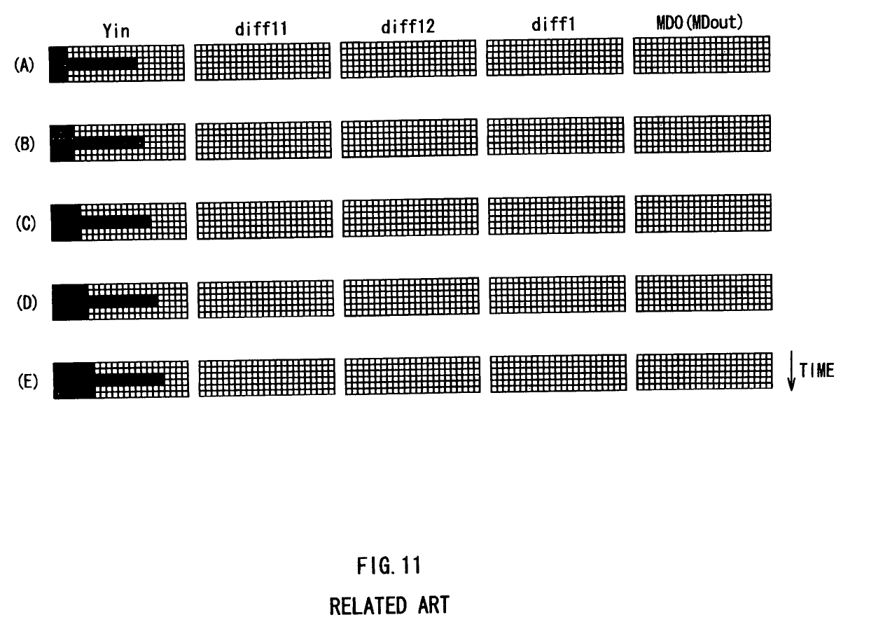

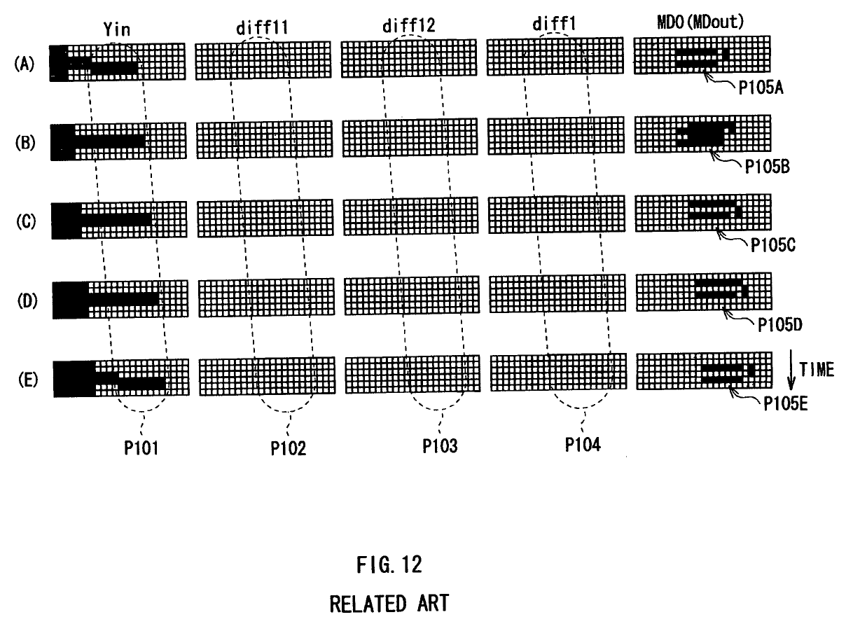

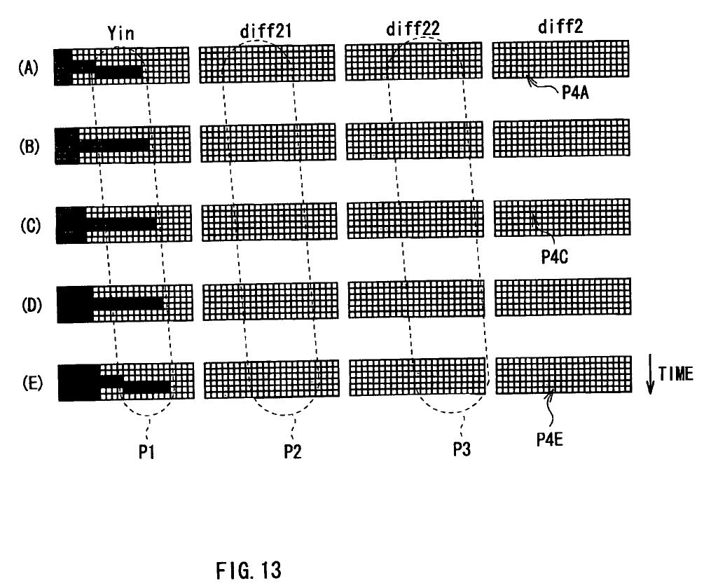

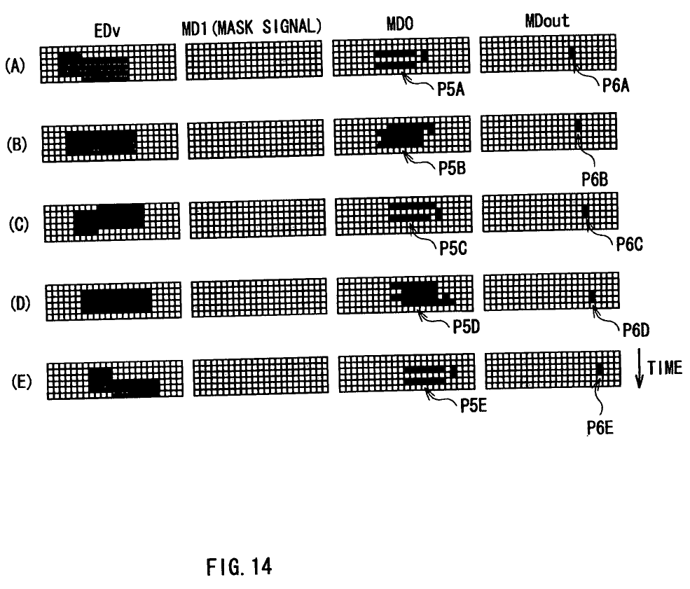

Next, referring to FIGS. 3 to 5 and 9 to 14 in addition to FIGS. 1, 2, and 6 to 8, the operation of the motion detection section 431 (motion detection operation) as one of characteristic points of the invention will be described in detail below. FIG. 9 shows a block diagram of the whole configuration of an image display (an image display 101) according to a comparative example, and FIG. 10 shows a block diagram of a specific configuration of a motion detection section (a motion detection section 143A which will be described later) according to the comparative example. Moreover, FIGS. 11 and 12 show timing charts of an example of motion detection operation according to the comparative example, and FIGS. 13 and 14 show timing charts of an example of motion detection operation according to the embodiment, and each square in FIGS. 11 to 14 indicates each pixel on a screen. In addition, the image display 101 according to the comparative example corresponds to an image display in which instead of the motion detection section 431 in the embodiment, a conversion region detection section 143 including a motion detection section 143A shown in FIG. 10 is arranged in an image processing section 104.

At first, in the image display 101 according to the comparative example, in the motion detection section 143A shown in FIG. 10, on the basis of the inputted luminance signal Yin (the luminance signal Ya1 of a succeeding sub-frame period) and luminance signals (the luminance signal Yn of the current sub-frame period and the luminance signal Yp1 of a preceding sub-frame period) stored in a 2-sub-frame memory 170, as shown by reference numerals P111 and P112 in FIG. 4, the difference signal dff11 between the luminance signals Yn and Yp1 and the difference signal dff12 between the luminance signals Yn and Ya1 are generated by the difference•absolute value processing section 711 and the difference•absolute value processing section 712, respectively, and the OR processing signal (the logical sum signal) diff1 of the two difference signals diff11 and diff12 is generated by the OR processing section 713, and the motion detection process on the OR processing signal diff1 for each pixel is executed by the motion detection execution section 714, thereby the motion information MD0 is generated and outputted as the motion information MDout which is a final output result.

Therefore, in the case where like the luminance signal Yin shown in FIGS. 11(A) to 11(E), a predetermined picture is moved pixel by pixel from the left to the right on the screen during sub-frame periods, when a line flicker component according to IP conversion is not contained in the luminance signal Yin, each output is stable (fluctuations in a signal do not occur on a line of sight of pursuit eye movement) as in the case of the difference signals diff11 and diff12 and the OR processing signal diff1 shown in the drawing, so it is clear that stable and intrinsic motion information is obtained in the motion information MD0 (MDout) shown in the drawing.

However, in the case where like the luminance signal Yin shown in FIGS. 12(A) to 12(E), the line flicker component (P101 in the drawing) generated at the time of IP conversion by the IP conversion section 40 is contained in the luminance signal Yin, each output is not stable (as shown by reference numerals P102 to P104 in the drawing, fluctuations in a signal occur on a line of sight of pursuit eye movement) as in the case of the difference signals diff11 and diff12 and the OR processing signal diff1 in the drawing, so also in the motion information MD0 (MDout) shown in the drawing, as shown by reference numerals P105A and P105E in the drawing, fluctuations in a motion information detection region (a processing region for improved pseudo impulse drive) due to the line flicker component occur, and it is clear that stable and intrinsic motion information is not obtained. When such fluctuations in the motion information detection region due to the line flicker component occur, a gray-scale expression balance by a combination of light and dark gray scales in improved pseudo impulse drive is lost, and as a result, a noise or flicker may occur in a displayed picture to cause degradation in picture quality.

More specifically, in the improved pseudo impulse drive, gray-scale expression is performed by, for example, a combination of the luminance γ characteristics γ1H and γ1L in FIG. 2 (or a combination of the luminance γ characteristics γ2H and γ2L or the like); however, when fluctuations in the motion information detection region due to the line flicker component occur as described above, the luminance γ characteristics γ1H and γ0 or the luminance γ characteristics γ1L and γ0 may be combined momentarily, and in such a case, luminance is lighter or darker than the original luminance, thereby a noise or flicker occurs in a displayed picture.

Therefore, in the image display 1 according to the embodiment, in the motion detection section 431 shown in FIG. 3, the following motion detection operation is performed. More specifically, at first, in the motion detection processing section 71, on the basis of the inputted luminance signal Yin (the luminance signal Ya4 of a sub-frame period which follows the current sub-frame period by four sub-frame periods) and luminance signals for 8 sub-frame periods stored in the 8-sub-frame memory 70 (the luminance signal Yn of the current sub-frame period, the luminance signal Yp4 of a sub-frame period which precedes the current sub-frame period by four sub-frame periods, the luminance signal Yp3 of a sub-frame period which precedes the current sub-frame period by three sub-frame periods, the luminance signal Yp2 of a sub-frame period which precedes the current sub-frame period by two sub-frame periods, the luminance signal Yp1 of a preceding sub-frame period, the luminance signal Ya1 of a succeeding sub-frame period, the luminance signal Ya2 of a sub-frame period which follows the current sub-frame period by two sub-frame periods, and the luminance signal Ya3 of a sub-frame period which follows the current sub-frame period by three sub-frame periods), as in the case of the motion detection processing section 70 in the motion detection section 143A according to the above-described comparative example, for example, the motion information MD0 as shown in FIGS. 14(A) to 14(E) is generated and outputted. In other words, as in the case of FIGS. 12(A) to 12(E), for example, in the case where like the luminance signal Yin shown in FIGS. 13(A) to 13(E), the line flicker component (a reference numeral P1 in the drawing) is contained in the luminance signal Yin, as shown by reference numerals P5A to P5E in FIG. 13, fluctuations in the motion information detection region due to the line flicker component occur even in the motion information MD0, and stable and intrinsic motion information is not obtained.

In the mask signal generation section 72 in the embodiment, at first, on the basis of the inputted luminance signal Yin (the luminance signal Ya4) and luminance signals for 8 sub-frame periods stored in the 8-sub-frame memory 70, for example as shown by reference numerals P11 and P12 in FIG. 4, the difference signal diff21 between the luminance signals Yn and Yp4 and the difference signal diff22 between the luminance signals Yn and Ya4 are generated by the difference•absolute value processing section 721 and the difference•absolute value processing section 722, respectively, and the AND processing signal (the logical product signal) diff2 of the two difference signals diff21 and diff22 is generated by the AND processing section 713. At this time, the difference signals between the luminance signal Yin of the current sub-frame period and the luminance signals Yp4 and Ya4 of sub-frame periods which are four sub-frame periods before and after the current sub-frame period are generated, because a change cycle of the line flicker component generated at the time of IP conversion is equal to two unit frame periods (in this case, 4 sub-frame periods) as can be seen from a reference numeral P1 in FIGS. 13(A) to 13(E), so it is difficult to remove fluctuations in the motion information detection region due to the line flicker component by the difference signals between the luminance signal Yn of the current sub-frame period and the luminance signals Yp1 and Ya1 of preceding and succeeding sub-frame periods which are generated by the difference•absolute value processing sections 711 and 712 in the motion detection processing section 71. In addition, it is clear that, for example, as shown in FIGS. 13(A) to 13(E), in the difference signals diff21 and diff22 generated in such a manner, each output is still unstable (as shown by reference numerals P2 and P3 in the drawing, fluctuations in a signal occur on a line of sight of pursuit eye movement); however, in the AND processing signal (the logical product signal) diff2 between them, as shown by reference numerals P4A to P4E in the drawing, fluctuations in the motion information detection region due to such a line flicker component are almost removed.

On the other hand, in the V-direction edge detection section 724 in the mask signal generation section 72, vertical-direction (V-direction) edge information in the luminance signal Yn of the current sub-frame period for each pixel is detected, thereby for example, vertical edge information EDv shown in FIGS. 14(A) to 14(E) is obtained. Such vertical-direction edge information is detected, because most of line flicker components generated at the time of IP conversion are generated in a vertical-direction edge portion, so a line flicker component existing region in the luminance signal Yin is specified.

Next, in the edge adaptive motion detection section 725, adaptive motion detection is performed on the AND processing signal diff2 on the basis of the AND processing signal diff2 generated by the AND processing section 723 and the vertical edge information EDv detected by the V-direction edge detection section 724 to generate the mask signal MD1 for each pixel. More specifically, the detection threshold value TH for the adaptive motion detection shown in, for example, FIG. 5 is adaptively changed on the basis of the vertical edge information EDv to generate the mask signal MD1. More specifically, as shown in FIG. 5, in a region (a vertical edge detection region) where the value of the vertical edge information EDv is 100%, the detection threshold value TH is adaptively set so that a temporally unstable region remaining in the AND processing signal diff2 is not motion-detected (so that the AND processing signal diff2 becomes “0 (zero)” in each pixel), and on the other hand, the detection threshold value TH is set to 0 in a region where the vertical edge information EDv is equal to or higher than 0% and less than 100% (a region other than the vertical edge detection region), thereby the mask signal MD1 (refer to FIG. 14(A) to 14(E)) as motion information is generated by the edge adaptive detection section 725. At this time, the reason why a temporally unstable region remaining in the AND processing signal diff2 is prevented from being motion-detected is because there is a high possibility that a line flicker component according to IP conversion is contained in the vertical edge detection region. As shown in FIGS. 14(A) to 14(E), it is clear that the mask signal MD1 is a reversed signal of the vertical edge information EDv in this case, and substantially matches a fluctuation portion of the motion information detection region due to the line flicker component contained in the motion detection signal MD0.

Finally, in the AND processing section 73, a mask process (AND processing (logical product operation processing)) is performed on the motion information MD0 for each pixel through the use of the mask signal MD1 generated by the mask signal generation section 72, thereby the motion information MDout as a final output result is generated and outputted to the detection synthesization section 433. Herein, it is clear that in the motion information MDout subjected to such a mask process, as shown in FIGS. 14(A) to 14(E), the flucuation portion of the motion information detection region due to the line flicker component contained in the motion detection signal MD0 is almost removed except for a portion indicated by reference numerals P6A to P6E in the drawing.

Thus, in the image processing section 4 according to the embodiment, frame rate conversion from the video signal D0 to the video signal D1 is performed by dividing the unit frame period of the video signal D0 on the basis of the TV signal Din into two sub-frame periods SF1 and SF2, and the motion information MDout and the edge information EDout of the video signal D1 are detected for each pixel. Then, selective adaptive gray-scale conversion is performed on the video signal in a pixel region (a detection region) in which the motion information MDout and the edge information EDout larger than a predetermined threshold value is detected from the video signal D1 so that while the time integral value of luminance in the unit frame period is maintained, a high luminance period (the sub-frame period SF1) and a low luminance period (the sub-frame period SF2) are allocated to the sub-frame periods SF1 and SF2 in the unit frame period. Thus, adaptive gray-scale conversion is selectively performed on the video signal in a pixel region (a detection region) in which the motion information MDout and the edge information EDout are larger than the predetermined threshold value, so while the motion picture response is improved in the detection region by pseudo impulse drive, and a sense of flicker is reduced in a pixel region other than the detection region by normal drive. Therefore, compared to the case where adaptive gray-scale conversion is performed on the video signals in the whole pixel region as in the case of related art, while high motion picture response is maintained, the sense of flicker is reduced.

Moreover, in the case where a line flicker component generated at the time of IP conversion by the IP conversion section 40 is included in the luminance signal Yin on the basis of the video signal D1, the mask signal MD1 for the fluctuation pixel region where the motion information MD0 fluctuates due to the line flicker component is generated on the basis of the luminance signal Yin by the mask signal generation section 72, and in the case where the above-described fluctuation pixel region is included in the motion information MD0 detected by the motion detection processing section 71, a mask process on the motion information MD0 detected through the use of the mask signal MD1 is performed for each pixel by the AND processing section 73, and the above-described adaptive gray-scale conversion is performed on the basis of the motion information MDout subjected to such a mask process, so even in the case where a line flicker component is contained in the video signal D1 (the luminance signal Yin), fluctuations in the motion information due to such a line flicker component are prevented, and the detected motion information is stabilized along a time axis.

As described above, in the embodiment, the unit frame period of the video signal D0 on the basis of the TV signal Din is divided into a plurality of sub-frame periods SF1 and SF2 to perform frame rate conversion, thereby generating the video signal D1, and the motion information MDout and the edge information EDout of the video signal D1 are detected for each pixel, and adaptive gray-scale conversion is selectively performed on the video signal in a pixel region (a detection region) in which the motion information MDout and the edge information EDout larger than the predetermined threshold value are detected from the video signal D1 so that while the time integral value of luminance in the unit frame period is maintained, the high luminance period (the sub-frame period SF1) and the low luminance period (the sub-frame period SF2) are allocated to the sub-frame periods SF1 and SF2 in the unit frame period, so the motion picture response is improved by pseudo impulse drive, and compared to the case where adaptive gray-scale conversion is performed on the luminance signals in the whole pixel region in related art, the sense of flicker is reduced. Moreover, in the case where a line flicker component generated by IP conversion is contained in the luminance signal Yin on the basis of the video signal D1, the mask signal MD1 for the fluctuation pixel region where the motion information MD0 fluctuates due to the line flicker component is generated on the basis of the luminance signal Yin, and in the case where the above-described fluctuation pixel region is included in the detected motion information MD0, a mask process on the motion information MD0 is performed for each pixel through the use of the mask signal MD1, and the above-described adaptive gray-scale conversion is performed on the basis of the motion information MDout subjected to such a mask process, so even in the case where a line flicker component is contained in the video signal D1 (the luminance signal Yin), fluctuations in the motion information due to such a line flicker component are prevented, thereby the detected motion information is able to be stabilized along the time axis. Therefore, pronounced gray scale degradation around the line flicker component is prevented, and noises due to fluctuations in such gray scale degradation are able to be reduced, so irrespective of the presence or absence of a line flicker component in an input picture, a balance between a reduction in the sense of flicker and an improvement in motion picture response is achieved.

Although the present invention is described referring to the embodiment, the invention is not limited to the embodiment, and may be variously modified.

For example, in the above-described embodiment, the case where a mask process is performed through the use of the mask signal MD1 generated by the mask signal generation section 72 in the AND processing section 73 is described; however, in some cases, the AND processing section 73 may directly obtain a mask signal generated in the IP conversion section to perform a mask process through the use of the mask signal.

Moreover, in the above-described embodiment, the case where adaptive gray-scale conversion is selectively performed in a pixel region in which the motion information MDout and the edge information EDout are larger than the predetermined threshold value as a conversion processing region (a detection region) is described; however, more typically, adaptive gray-scale conversion may be selectively performed in a pixel region in which at least one of the motion information MDout and the edge information EDout is larger than a predetermined threshold value as a conversion processing region (a detection region).

Further, in the above-described embodiment, the case where one unit frame period includes two sub-frame periods SF1 and SF2 is described; however, the frame rate conversion section 41 may perform frame rate conversion so that one unit frame period includes three or more sub-frame periods.

Moreover, in the above-described embodiment, as an example of the image display, the liquid crystal display 1 including the liquid crystal display panel 2 and the backlight section 3 is described; however, the image processing apparatus according to the invention is applicable to any other image displays, that is, for example, plasma display panels (PDPs) or EL (ElectroLuminescence) displays.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus comprising:
a detection means for detecting a motion index of an input picture for each pixel;
a generation means for generating, on the basis of the input picture, a mask signal for a fluctuation pixel region where the motion index fluctuates due to a line flicker component contained in the input picture;
a mask processing means for performing a mask process on the motion index for each pixel through the use of the mask signal;
a frame division means for dividing a unit frame period of the input picture into a plurality of sub-frame periods; and
a gray-scale conversion means for selectively performing, on the basis of the motion index subjected to the mask process, adaptive gray-scale conversion on a luminance signal in a pixel region where a motion index larger than a predetermined threshold value is detected from the luminance signal of the input picture so that, while maintaining total time integral value of the luminance signal in the unit frame period as it is, a high luminance period having a luminance level higher than an original luminance signal and a low luminance period having a luminance level lower than the original luminance signal are allocated to sub-frame periods in the unit frame period, respectively.

2. The image processing apparatus according to claim 1, wherein
the generation means includes:
a difference signal generation means for generating, for each pixel, a first difference signal as a difference signal between the current input picture and an input picture of a sub-frame period which precedes the current input picture by four sub-frame periods, and a second difference signal as a difference signal between the current input picture and an input picture of a sub-frame period which follows the current input picture by four sub-frame periods;
a vertical edge detection means for detecting an edge index in a vertical direction of the current input picture for each pixel; and
a mask signal generation means for generating the mask signal for each pixel on the basis of the first and the second difference signals generated and the edge index.

3. The image processing apparatus according to claim 2, wherein
the mask signal generation means performs adaptive motion detection on each pixel through the use of the edge index so that a logical product signal of the first difference signal and the second difference signal is masked to 0 (zero) in each pixel, resulting in the mask signal.

4. The image processing apparatus according to claim 3, wherein
the mask signal generation means adaptively changes, on the basis of the edge index, a detection threshold value in each pixel for the adaptive motion detection so that the logical product signal results in 0 (zero) for each pixel.

5. The image processing apparatus according to claim 1, wherein
the detection means detects the motion index of an input picture on the basis of difference signals for each pixel between the current input picture and input pictures of preceding and succeeding sub-frame periods.

6. An image display comprising:
a detection means for detecting a motion index of an input picture for each pixel;
a generation means for generating, on the basis of the input picture, a mask signal for a fluctuation pixel region where the motion index fluctuates due to a line flicker component contained in the input picture;
a mask processing means for performing a mask process on the motion index for each pixel through the use of the mask signal;
a frame division means for dividing a unit frame period of the input picture into a plurality of sub-frame periods;
a gray-scale conversion means for selectively performing, on the basis of the motion index subjected to the mask process, adaptive gray-scale conversion on a luminance signal in a pixel region where a motion index larger than a predetermined threshold value is detected from the luminance signal of the input picture so that, while maintaining total time integral value of the luminance signal in the unit frame period as it is, a high luminance period having a luminance level higher than an original luminance signal and a low luminance period having a luminance level lower than the original luminance signal are allocated to sub-frame periods in the unit frame period, respectively; and
a display means for displaying a picture on the basis of a luminance signal subjected to adaptive gray-scale conversion by the gray-scale conversion means.

7. An image processing method comprising:
a detection step of detecting a motion index of an input picture for each pixel;
a generation step of generating, on the basis of the input picture, a mask signal for a fluctuation pixel region where the motion index fluctuates due to a line flicker component contained in the input picture;
a mask processing step of performing a mask process on the motion index for each pixel through the use of the mask signal;
a frame division step of dividing a unit frame period of the input picture into a plurality of sub-frame periods; and
a gray-scale conversion step of selectively performing, on the basis of the motion index subjected to the mask process, adaptive gray-scale conversion on a luminance signal in a pixel region where a motion index larger than a predetermined threshold value is detected from the luminance signal of the input picture so that, while maintaining total time integral value of the luminance signal in the unit frame period as it is, a high luminance period having a luminance level higher than an original luminance signal and a low luminance period having a luminance level lower than the original luminance signal are allocated to sub-frame periods in the unit frame period, respectively.

8. An image processing apparatus comprising:
a detection section detecting a motion index of an input picture for each pixel;
a generation section generating, on the basis of the input picture, a mask signal for a fluctuation pixel region where the motion index fluctuates due to a line flicker component contained in the input picture;
a mask processing section performing a mask process on the motion index for each pixel through the use of the mask signal;
a frame division section dividing a unit frame period of the input picture into a plurality of sub-frame periods; and
a gray-scale conversion section selectively performing, on the basis of the motion index subjected to the mask process, adaptive gray-scale conversion on a luminance signal in a pixel region where a motion index larger than a predetermined threshold value is detected from the luminance signal of the input picture so that, while maintaining total time integral value of the luminance signal in the unit frame period as it is, a high luminance period having a luminance level higher than an original luminance signal and a low luminance period having a luminance level lower than the original luminance signal are allocated to sub-frame periods in the unit frame period, respectively.

9. An image display comprising:
a detection section detecting a motion index of an input picture for each pixel;
a generation section generating, on the basis of the input picture, a mask signal for a fluctuation pixel region where the motion index fluctuates due to a line flicker component contained in the input picture;
a mask processing section performing a mask process on the motion index for each pixel through the use of the mask signal;
a frame division section dividing a unit frame period of the input picture into a plurality of sub-frame periods;
a gray-scale conversion section selectively performing, on the basis of the motion index subjected to the mask process, adaptive gray-scale conversion on a luminance signal in a pixel region where a motion index larger than a predetermined threshold value is detected from the luminance signal of the input picture so that, while maintaining total time integral value of the luminance signal in the unit frame period as it is, a high luminance period having a luminance level higher than an original luminance signal and a low luminance period having a luminance level lower than the original luminance signal are allocated to sub-frame periods in the unit frame period, respectively; and
a display section displaying a picture on the basis of a luminance signal subjected to adaptive gray-scale conversion by the gray-scale conversion section.
